(19) United States
(12) Patent Application Publication
(10) Pub. No.: US 2008/0298071 A1
(43) Pub. Date: Dec. 4, 2008

(54) LED LIGHTING DEVICE (2)

(76) Inventor: CHING-HANG SHEN, Kaohsiung (TW)

Correspondence Address: G. LINK CO., LTD., 3550 BELL ROAD, MINOOKA, IL, 60447, US

(21) Appl. No.: 11/757,392

(22) Filed: Jun. 3, 2007

(51) Int. Cl. F21V 7/00; F21V 3/00

(52) U.S. Cl. 362/307; 362/311

(57) ABSTRACT

A LED lighting device includes a light hood, a base and a LED. The light hood has a hood wall and an open side. The base is disposed in and joined to the hood wall to be opposite to the open side. The LED is disposed in and attached to the base. A polygon surface shaped light-pervious plate is disposed at the open side and light emitted from the LED is capable of being spread outward through the polygon surface shaped light-pervious plate.

### BACKGROUND OF THE INVENTION

1. Field of the Invention

The present invention is related to a LED lighting device and particularly to a lighting device with a light source of light emitting diode (LED).

2. Brief Description of the Related Art

The LED has been widely used as a light source of a lighting device due to LED being small in size, low in power consumption and low in heat generation and providing different wavelengths (colors).

Referring to FIG. 1, the conventional LED lighting device provides a light hood 11, a base 12 and a LED 13. The LED 13 is attached to the base 12 and the light hood 11 encloses the base 12 and the LED 13. The base 12 is a circuit board and supplies power to LED 13. A light penetrable plate 14 is disposed at the opening of the light hood 11. The LED 13 is protected with the light hood 11 and the light penetrable plate 14 from being hit and damaged and emits light outward through the light penetrable plate 14.

The light penetrable plate 14 is made of glass or acrylic. The glass basically is fabricated with non-crystal SiO₂ mixed with soda and limestone being melted in a high temperature furnace. The acrylic is fabricated with melted high molecular resin being poured into a mold.

The light penetrable plate 14 has a smooth surface but the LED 13 emits straight light beam instead of diffusion light of the traditional fluorescent light such that the lighting area of the LED 13 is very limited. In order to increase the lighting area for the LED 13, more LEDs have to be added and cost increases too.

### SUMMARY OF THE INVENTION

Accordingly, in order to overcome the preceding deficiency, an object of the present invention is to provide an LED lighting device capable of expanding the lighting area thereof.

In order to achieve the preceding object, an LED lighting device according to the present invention includes a light hood, a base and a LED. The light hood has a hood wall and an open side. The base is disposed in and joined to the hood wall to be opposite to the open side. The LED is disposed in and attached to the base. A polygon surface shaped light-pervious plate is disposed at the open side and light emitted from the LED is capable of being spread outward through the polygon surface shaped light-pervious plate.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a disassembled sectional view of the conventional lighting device;

FIG. 2 is a disassembled sectional view of an LED lighting device according to the present invention; and

FIG. 3 is an assembled sectional view of the LED lighting device shown in FIG. 2.

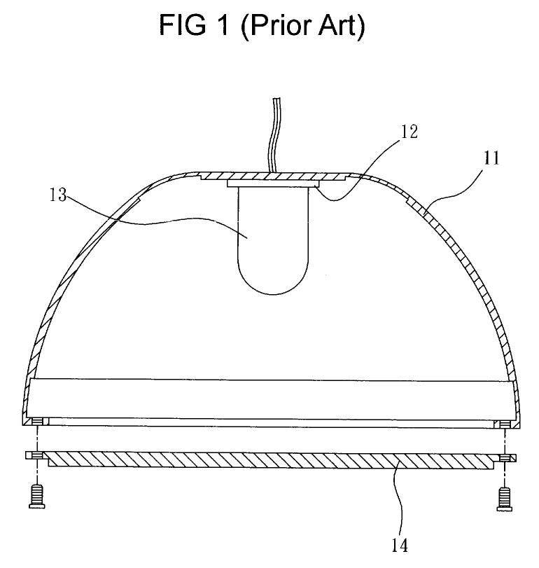

### DETAILED DESCRIPTION OF THE INVENTION

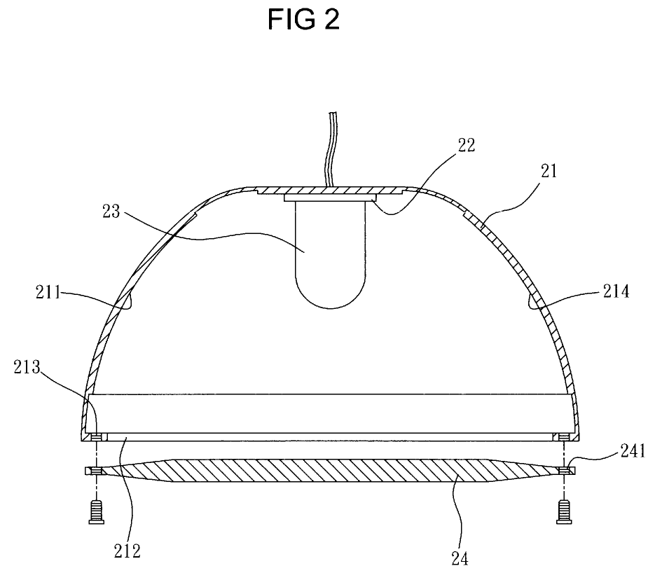

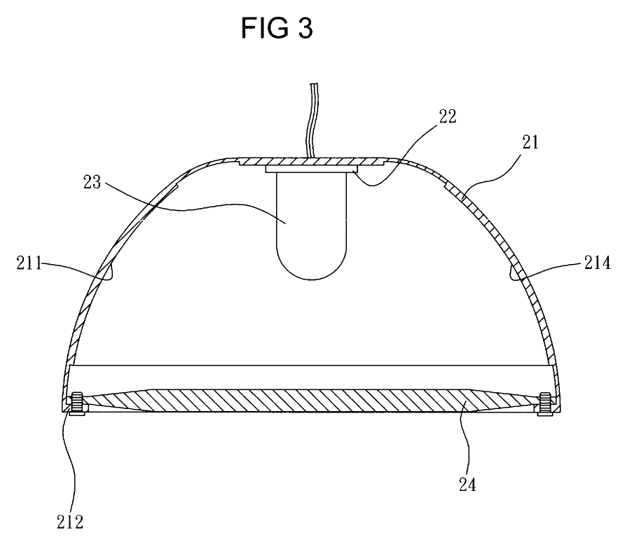

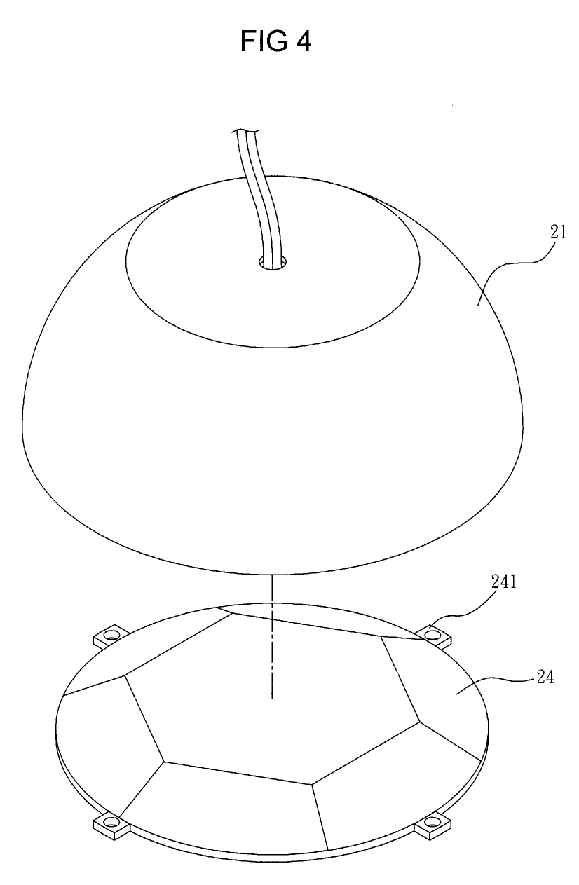

Referring to FIG. 2, an LED lighting device includes a light hood 21, a base 22 and a light emitting diode (LED). The LED 23 is arranged the surface of the base 22 and the light hood 21 encloses the base 22 and the LED 23. The LED 23 provides a polygon surface shaped light-pervious plate 24 in front of the LED to be attached to light hood 21.

The light hood 21 has a hood wall 211 and an open side 212. The open side 212 is surrounded with a joining part 213 attached to the hood wall 211. The inner side of the hood wall 211 is a reflection unit 214 with a reflection surface. The polygon surface shaped light-pervious plate 24 has a reflection surface and provides an engaging part 241 corresponding to the joining part 213 such that the polygon surface shaped light-pervious plate 24 is capable of being attached to the light hood 21.

The base 22 is a circuit board to supply power to the LED 23. The LED 23 emits light by means of electronics being associated with the electronic holes for releasing energy. The LED 23 is small in size, long in life span, low in driving voltage, low in power consumption, fast in reaction speed, good in shock resistance and in showing single color.

The polygon surface shaped light-pervious plate 24 is composed of a plurality of planes in different orientations. The material of the light-pervious plate 24 can be glass, acrylic, quartz, quartz glass or any combinations of the preceding materials. Hence, the limited lighting from the LED 23 can be spread outward via the polygon surface shaped light-pervious plate 24 to improve the original lighting area of the LED 23. Further, less numbers of the LED 23 are used in a place with large area.

Further, the reflection unit 214 is capable of reflecting weak light source, which is beamed from the LED 23 in the light hood 21, and the reflected light is shined outward with the quartz light-pervious plate 24.

While the invention has been described with referencing to preferred embodiments thereof, it is to be understood that modifications or variations may be easily made without departing from the spirit of this invention, which is defined by the appended claims.

What is claimed is:

1. A LED lighting device comprising:
a light hood providing a hood wall and an open side;
a base being disposed in and attached to the hood wall to be opposite to the open side; and
an LED being disposed in and attached to the base;
wherein a polygon surface shaped light-pervious plate is disposed at the open side and light emitted from the LED is capable of being spread outward through the polygon surface shaped light-pervious plate.

2. The LED lighting device as defined in claim 1, wherein the open side is surrounded with a first engaging part.

3. The LED lighting device as defined in claim 1, wherein the polygon surface shaped light-pervious plate provides a second engaging part corresponding to the first engaging part.

4. The LED lighting device as defined in claim 1, wherein an inner side of the hood wall has a reflection unit.

5. The LED lighting device as defined in claim 4, wherein the reflection unit has a reflection surface.

6. The LED lighting device as defined in claim 1, wherein the base is a circuit board to supply power to the LED.

7. The LED lighting device as defined in claim 1, wherein the polygon surface shaped light-pervious plate is composed a plurality of planes in different orientations.

8. The LED lighting device as defined in claim 1, wherein the polygon surface shaped light-pervious plate is made of glass, acrylic, quartz, quartz glass or one of any combinations of the preceding material.
